(19) United States
(12) Patent Application Publication
(10) Pub. No.: US 2023/0016804 A1
(43) Pub. Date: Jan. 19, 2023

(54) Shock Collar with Slider Remote and Wireless Charging Pad

(71) Applicant: Moris Rabiean, Los Angeles, CA (US)

(72) Inventor: Moris Rabiean, Los Angeles, CA (US)

(21) Appl. No.: 17/810,453

(22) Filed: Jul. 1, 2022

Related U.S. Application Data
(60) Provisional application No. 63/222,216, filed on Jul. 15, 2021.

(51) Int. Cl. A01K 27/00; G08C 17/00

(52) U.S. Cl. CPC A01K 27/009; G08C 17/00; H02J 50/00

(57) ABSTRACT

The present invention provides a behavior control device that comprises a remote unit for controlling an electronic collar device for an animal. The remote unit includes a front housing member having a curved channel formed along a front surface of the front housing member, the curved channel includes a vibration section and a shock section connected to the vibration section, the curved channel is curved at a point where the vibration section and the shock section is connected, a rear housing member, and a sliding member movable along the curved channel between the vibration section and the shock section.

### FIELD OF THE INVENTION

The present invention generally relates to systems for animal behavior control. More specifically, the present invention relates to a remote device with a unique design for use in controlling the behavior of animals.

### BACKGROUND OF THE INVENTION

A remote device to control the behavior of animals is in demand. In the field of animal training, owners or trainers have used various devices to correct animals' behavior.

Animal training systems are available that include a collar-type device and a remote controller that can wirelessly communicate with the collar-type device. A user can take control to deliver stimulation, such as electrical stimulation, to the collar-type device through the remote controller to correct behaviors of a dog, such as barking, going beyond a preset boundary, or attacking humans.

Dog shock collars and remote devices are used to train dogs, primarily to stop them from barking, scratching, running away, attacking other dogs, jumping on people, and so on. When a dog misbehaves, users can use different levels of vibration until the dog stops the unwanted behavior. If vibration does not work, the user can apply various levels of shock until the dog stops the behavior. However, the control devices currently available do not allow convenient changing among the signals sent to the dog so as to adapt to the changing behaviors of the dog or to avoid unwanted signals that could harm the dog. Thus, there is a need to develop a device that solves this problem.

The present invention is intended to address problems associated with and/or otherwise improve on conventional systems and devices through an innovative behavior control device that is designed to provide a convenient and effective means of controlling animal behaviors while incorporating other problem-solving features.

### SUMMARY

In accordance with the present invention, a novel behavior control device is provided. The behavior control device comprises a remote unit for controlling an electronic collar device for an animal.

In one embodiment, the remote unit includes a front housing member having a curved channel formed along a front surface of the front housing member, the curved channel includes a vibration section and a shock section connected to the vibration section, the curved channel is curved at a point where the vibration section and the shock section is connected, a rear housing member, and a sliding member movable along the curved channel between the vibration section and the shock section.

In another embodiment, the sliding member can include a button that can be pushed to allow the sliding member to move, and when the button is released, the button can lock the sliding member's position on the curved channel.

### BRIEF DESCRIPTION OF THE DRAWINGS

FIG. 1 is an illustration of one embodiment of the present invention.

FIG. 2 is an illustration of one embodiment of the present invention in communication with an electronic collar device mounted on a dog.

FIG. 3 is an illustration of an alternative embodiment of the present invention with a transmitter and a microprocessor.

FIG. 4 is an illustration of one embodiment of the present invention showing a vibration section and a shock section.

FIG. 5 is a sideview of one embodiment of the present invention showing a front housing member and a rear housing member.

FIG. 6 is an illustration of a cross section of one embodiment of the present invention showing a spring-loaded slider.

FIG. 7 is an illustration showing one embodiment of the present invention and the electronic collar device placed on a wireless charging pad.

### DETAIL DESCRIPTIONS OF THE INVENTION

All illustrations of the drawings are for the purpose of describing selected versions of the present invention and are not intended to limit the scope of the present invention.

The present invention provides a device for controlling the behavior of an animal.

The present invention includes a unique control mechanism by which the user can conveniently control the behavior of an animal.

The present invention can be used to manage a pet or animal such as a dog. For purposes of explanation, and not by way of limitation, the present invention is described herein as a behavior control device for controlling the behavior of an animal.

Persons with ordinary skill in the art will recognize that various aspects of the present invention could also be used to control cats, other pets, farm animals, livestock, zoo animals, and so forth.

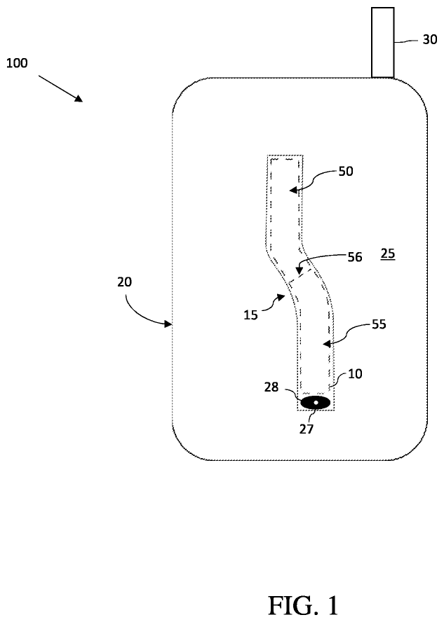

As FIGS. 1 to 7 show, the present invention provides a behavior control device 100 that comprises a remote unit 20.

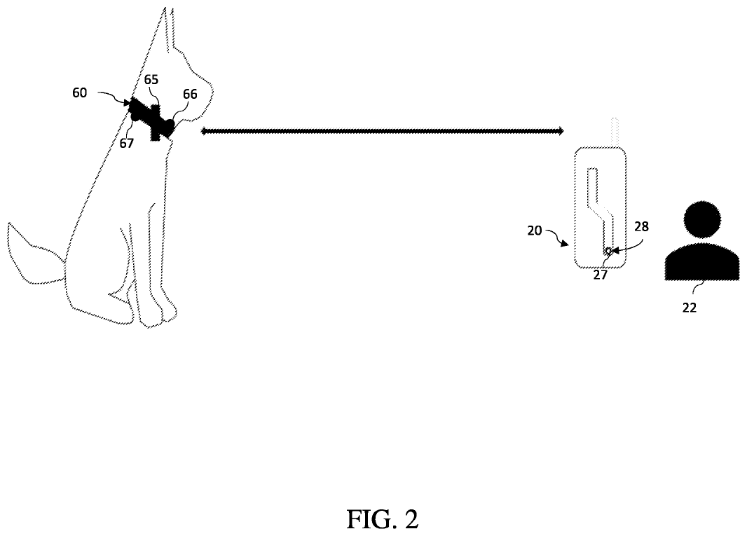

As FIG. 2 shows, the remote unit 20 controlled by a user 22 can be configured to communicate with and for controlling an electronic collar device 60 that can be attached to a dog by a collar, harness, implant, or the like.

The electronic collar device 60 may include a receiver 65 for receiving control signals from the remote unit 20 for controlling at least one vibration device 66 or at least one shock device 67 attached to or contained within the electronic collar device 60.

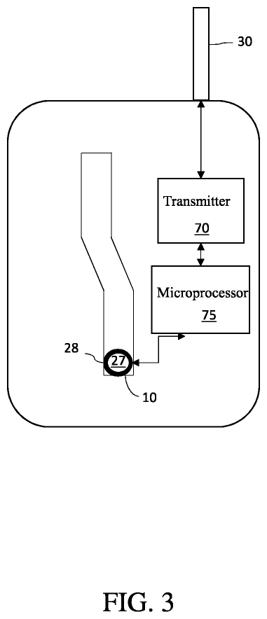

As FIG. 3 shows, the remote unit 20 may include a transmitter 70 for transmitting the control signals to the receiver and a microprocessor 75 connected to the transmitter 70. The microprocessor 75 can be configured to cause the transmitter 70 to transmit the control signals to the receiver 65 for controlling the at least one device (e.g., the vibration device 66 or the shock device 67 or any other controllable device including a sound device) attached to or contained within the electronic collar device 60.

In one embodiment, the remote unit 20 may include a housing 25 and a sliding member 28, with the housing 25 including a curved channel 10 (e.g., a slider opening or a slot for the sliding member) to slide in.

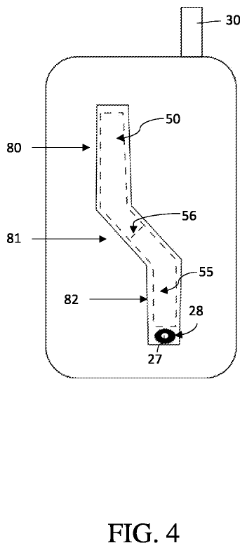

The sliding member (slider) 28 is positioned in the curved channel (slider opening) 10, providing a path on the housing 25 for the sliding member 28 to slide along the path. The curved channel 10 can include three sections: a first portion 80, a second portion 81, and a third portion 82, as shown in FIG. 4. In some embodiment, the first portion 80 can include a shock section 50 and the third portion can include a vibration section 55. The vibration section 55 and the shock section 50 can meet in the second portion 81.

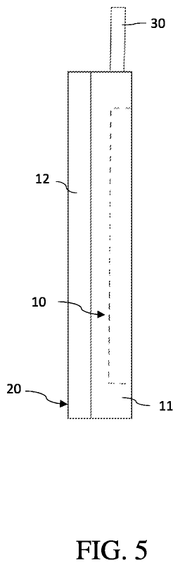

In another embodiments, as FIG. 5 shows, the remote unit 20 can include a front housing member 11 and a rear housing member 12. The front housing member 11 can include a curved channel 10 formed along a front surface of the front housing member 11. The curved channel 10 may include a vibration section 55 and a shock section 50 which is continuously connected to the vibration section 55, as FIG. 4 shows.

In some embodiments, the curved channel 10 is curved at a point 56 where the vibration section 55 and the shock section 50 are connected.

The rear housing member 12 can be removably attached to the front housing member 11.

The remote unit 20 can include a sliding member 28 positioned in the curved channel 10. The sliding member 28 can be connected to the microprocessor 75 and the sliding member 28 can be configured to move along the curved channel 10 between the vibration section 55 and the shock section 50. When the sliding member 28 is positioned in the vibration section 55 or the shock section 50, the microprocessor 75 causes the transmitter 70 to transmit the control signals to the receiver 65. When the sliding member 28 is positioned in the vibration section 55, the control signals may include signals for controlling a vibration intensity of the at least one vibration device 66. When the sliding member 28 is positioned in the shock section 50, the control signals may include signals for controlling a shock intensity of the at least one shock device 67. For example, the remote unit 20 can be configured to increase the intensity of the vibration when the sliding member 28 moves upward from the bottom of the curved channel 10 and increase the shock intensity when the sliding member 28 moves upward from the bottom of the shock section 50 which can be the point 56 where the shock section 50 is connected to the vibration section 55.

In some embodiments, the remote unit 20 may include an antenna 30 connected to the transmitter 70. The antenna 30 can be any type of antenna suitable for communicating with the electronic collar device 60.

In some embodiments, as shown in FIG. 2, the remote unit 20 may communicate with the electronic collar device 60 using the RF transceiver or any other wireless technology known in the art to receive status information and to send commands to the electronic collar device 60.

In some embodiments, the curved channel 10 may include three straight elongated channels 80, 81, 82 connected together, as shown in FIG. 4, and a middle portion of the three straight elongated channels 80, 81, 82 includes a point 56 where the vibration section 55 and the shock section 50 are connected.

In some embodiments, the curved channel 10 can be positioned along the length of the housing 20, substantially in its central area, which can be rectangular, so that the sliding member 28 can be moved up and down on the curved channel 10.

In some embodiments, the vibration section 55 can be positioned on the bottom portion of the curved channel 10, the curved section in the middle portion of the curved channel 10, and the shock section 50 in the upper portion of the curved channel 10.

In some embodiments, the sliding member 28 can include a button 27 (e.g., a push button or any type of button known in the art) that can be pushed to allow the sliding member 28 to move, and when the button 27 is released, the button 27 can lock the sliding member's 28 position on the curved channel 10.

In some other embodiments, the vibration section 55 and shock section 50 can be marked to indicate levels of intensity. For example, the vibration section 55 can be marked on the housing 20 from 1v to 5v, moving upward from the bottom position of the curved channel 10.

The curved section 15 of the curved channel 10 can be positioned in the middle of the curved channel 10 connecting the vibration section 55 and the shock section 50. This curved section 15 can be curved to require the user to exert extra effort before moving the sliding member 28 to the shock section 50 from the vibration section 55, thus avoiding accidentally sending a shock to the dog.

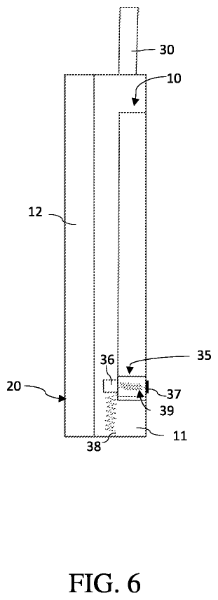

In some embodiments, as shown in FIG. 6, the sliding member 28 may include a spring-loaded slider 35 (attached to a slider spring 38) and a latch 36 (attached to a latch spring 39) that includes a latch button 37 positioned on the spring-loaded slider 35, the latch button 37 is configured to lock and release the latch 36 to allow the spring-loaded slider 35 to move along the curved channel 10. In such embodiments, the spring-loaded slider 35 can spring back to its original place once the latch button 37 on the slider is released.

The remote unit 20 of the present invention may be configured to send sound, vibration, and shock to the electronic collar device 60 and the remote unit 20 may be able to increase the intensity of vibration and shock using the sliding member 28. For example, the remote unit 20 may be configured so that once the button 27 is pressed, the remote unit 20 makes the electronic collar device 60 beep and frees the sliding member 28 to move around.

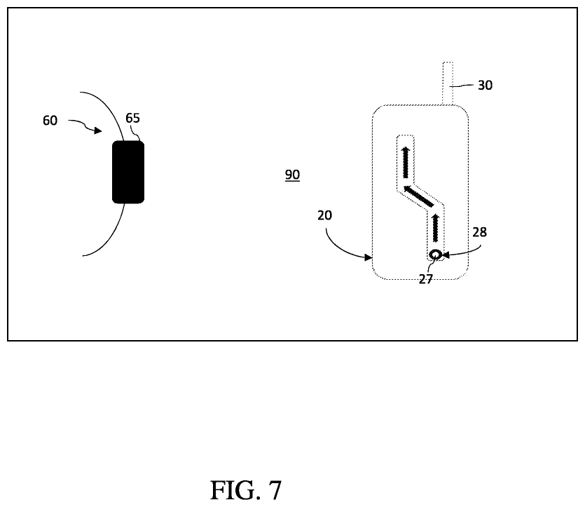

In some aspects, as shown in FIG. 7, the remote unit 20 may be loaded with wireless charging technology, allowing it to be charged when placed on a wireless charging pad 90, which can be any suitable charging pad known in the art.

In some other aspects, the electronic collar device 60 communicating with the remote unit 20 can also be configured to be wirelessly charged by a wireless charging pad 90.

Many available dog shock collars have remotes, but none uses a slider design— they all reserve a dedicated button for each function.

Traditionally, remotes have used three different buttons to activate sound, vibration, and shock, in combination with two more buttons to increase and decrease the intensity of vibrations and shocks. The present invention uses a single slider (sliding member 28) to control all these functions. When the user pushes the button 27 on the slider (sliding member 28), it beeps and frees the slider (sliding member 28) to move up or down.

In use, when a dog misbehaves, the user 22 can push the button 27 so that the present invention makes the dog's electronic collar device 60 beep. If the dog does not stop misbehaving, the user 22 can push the sliding member 28 upward to make the electronic collar device 60 vibrate. If the dog still does not stop misbehaving, the user 22 can push the sliding member 28 still farther upward to increase the intensity of the vibration. If the dog still does not respond, the user 22 can push the sliding member 28 farther still to administer a shock and may continue moving the sliding member 28 upward to increase the shock intensity until the dog stops. When the user 22 lets go of the sliding member 28, it quickly springs back into its original position at the bottom of the curved channel 10. All activities are stopped once the button 27 (or a latch button 37) on the sliding member 28 is released.

Although the invention has been explained in relation to its preferred embodiment, it is to be understood that many other possible modifications and variations can be made without departing from the spirit and scope of the invention.

What is claimed is:

1. A behavior control device comprising:
a remote unit for controlling an electronic collar device for an animal, the electronic collar device having a receiver for receiving control signals from the remote control unit for controlling at least one vibration device or at least one shock device attached to or contained within the electronic collar, the remote control unit includes:
a transmitter for transmitting the control signals to the receiver;
a microprocessor connected to the transmitter, the microprocessor adapted to cause the transmitter to transmit the control signals to the receiver for controlling the at least one device;
a front housing member having a curved channel formed along a front surface of the front housing member, the curved channel includes a vibration section and a shock section connected to the vibration section, the curved channel is curved at a point where the vibration section and the shock section are connected;
a rear housing member removably attached to the front housing member;
a sliding member positioned in the curved channel and connected to the microprocessor, wherein the sliding member is movable along the curved channel between the vibration section and the shock section; wherein when the sliding member is positioned in the vibration section or the shock section, the microprocessor causes the transmitter to transmit the control signals to the receiver; and
an antenna connected to the transmitter.

2. The behavior control device as claimed in claim 1, wherein when the sliding member is positioned in the vibration section, the control signals include signals for controlling a vibration intensity of the at least one vibration device.

3. The behavior control device as claimed in claim 1, wherein when the sliding member is positioned in the shock section, the control signals include signals for controlling a shock intensity of the at least one shock device.

4. The behavior control device as claimed in claim 1, wherein the sliding member includes a push button.

5. The behavior control device as claimed in claim 1, wherein the sliding member includes a spring-loaded slider and a latch that includes a latch button positioned on the spring-loaded slider, the latch button is configured to lock and release the latch to allow the spring-loaded slider to move along the curved channel.

6. The behavior control device as claimed in claim 1, wherein the remote unit is configured to be wirelessly charged by a wireless charging pad.

7. A behavior control device comprising:
a remote unit for controlling an electronic collar device for an animal, the electronic collar device having a receiver for receiving control signals from the remote control unit for controlling at least one vibration device or at least one shock device attached to or contained within the electronic collar, the remote control unit includes:
a transmitter for transmitting the control signals to the receiver;
a microprocessor connected to the transmitter, the microprocessor adapted to cause the transmitter to transmit the control signals to the receiver for controlling the at least one device;
a front housing member having a curved channel formed along a front surface of the front housing member, the curved channel includes a vibration section and a shock section connected to the vibration section, the curved channel includes at least one straight elongated channel and is curved at a point where the vibration section and the shock section are connected;
a rear housing member removably attached to the front housing member;
a sliding member positioned in the curved channel and connected to the microprocessor, wherein the sliding member is movable along the curved channel between the vibration section and the shock section; wherein when the sliding member is positioned in the vibration section and the shock section, the microprocessor causes the transmitter to transmit the control signals to the receiver; and
an antenna connected to the transmitter.

8. The behavior control device as claimed in claim 7, wherein when the sliding member is positioned in the vibration section, the control signals include signals for controlling a vibration intensity of the at least one vibration device.

9. The behavior control device as claimed in claim 7, wherein when the sliding member is positioned in the shock section, the control signals include signals for controlling a shock intensity of the at least one shock device.

10. The behavior control device as claimed in claim 7, wherein the sliding member includes a push button.

11. The behavior control device as claimed in claim 7, wherein the sliding member includes a spring-loaded slider and a latch that includes a latch button positioned on the spring-loaded slider, the latch button is configured to lock and release the latch to allow the spring-loaded slider to move along the curved channel.

12. The behavior control device as claimed in claim 7, wherein the remote unit is configured to be wirelessly charged by a wireless charging pad.

13. The behavior control device as claimed in claim 7, wherein the electronic collar is configured to be wirelessly charged by a wireless charging pad.

14. A behavior control device comprising:
a remote unit for controlling an electronic collar device for an animal, the electronic collar device having a receiver for receiving control signals from the remote control unit for controlling at least one vibration device or at least one shock device attached to or contained within the electronic collar, the remote control unit includes
a transmitter for transmitting the control signals to the receiver;
a microprocessor connected to the transmitter, the microprocessor adapted to cause the transmitter to transmit the control signals to the receiver for controlling the at least one device;
a front housing member having a curved channel formed along a front surface of the front housing member, the curved channel includes a vibration section and a shock section connected to the vibration section, the curved channel includes three straight elongated channels connected together and a middle portion of the three straight elongated channels includes a point where the vibration section and the shock section are connected;
a rear housing member removably attached to the front housing member;
a sliding member positioned in the curved channel and connected to the microprocessor, wherein the sliding member is movable along the curved channel between the vibration section and the shock section; wherein when the sliding member is positioned in the vibration section and the shock section, the microprocessor causes the transmitter to transmit the control signals to the receiver; and
an antenna connected to the transmitter.

15. The behavior control device as claimed in claim 14, wherein when the sliding member is positioned in the vibration section, the control signals include signals for controlling a vibration intensity of the at least one vibration device.

16. The behavior control device as claimed in claim 14, wherein when the sliding member is positioned in the shock section, the control signals include signals for controlling a shock intensity of the at least one shock device.

17. The behavior control device as claimed in claim 14, wherein the sliding member includes a push button.

18. The behavior control device as claimed in claim 14, wherein the sliding member includes a spring-loaded slider and a latch that includes a latch button positioned on the spring-loaded slider, the latch button is configured to lock and release the latch to allow the spring-loaded slider to move along the curved channel.

19. The behavior control device as claimed in claim 14, wherein the remote unit is configured to be wirelessly charged by a wireless charging pad.

20. The behavior control device as claimed in claim 14, wherein the electronic collar device is configured to be wirelessly charged by a wireless charging pad.
